(19) United States
(12) Patent Application Publication
(10) Pub. No.: US 2004/0077246 A1
(43) Pub. Date: Apr. 22, 2004

(54) Highly absorbent polyester fibers

(75) Inventors: Frederick L. Travelute III, Charlotte, NC (US); Stanley Kiser Hovis, Gastonia, NC (US)

Correspondence Address: SUMMA & ALLAN, P.A., 11610 NORTH COMMUNITY HOUSE ROAD, SUITE 200, CHARLOTTE, NC, 28277, US

(73) Assignee: Wellman, Inc., Charlotte, NC

(21) Appl. No.: 10/065,436

(22) Filed: Oct. 17, 2002

(51) Int. Cl. B32B 3/20; B32B 3/00

(52) U.S. Cl. 442/338; 442/327; 442/334; 442/335; 442/337; 428/304.4; 428/313.3; 264/165; 264/177.14

(57) ABSTRACT

A hollow polyester filament is disclosed that has sufficient openings therein for the hollow filament to substantially fill with water. The polyester filament has a moisture absorption capability of between about 10 and 30 percent by volume.

### BACKGROUND OF INVENTION

The present invention is related to materials useful for absorbing large amounts (relative to their own weight) of liquids and is particularly related to highly absorbent fibers that can be incorporated into absorbent structures for which fibers are desired or necessary, particularly structures that include nonwoven fabrics.

The present invention relates to liquid-absorbing materials. In particular, the invention relates to materials that will absorb water or aqueous solutions in amounts that are much greater than the amount (by weight or volume) of the absorbing material.

Common consumer uses or needs for liquid-absorbing structures include applications such as diapers, incontinence protection for adults, sanitary napkins, and tampons. Additional uses include filters, disposable wipes, mats shoe insoles, bed sheets, swellable gaskets or seals, moisture retention mats for horticulture, moisture retaining packaging (e.g. consumer meat packaging), and less visible uses that include self-sealing stitching threads, or yarn or fabric tape used to prevent or minimize water damage to underground electrical components such as buried cables and related equipment.

Such absorbing structures generally incorporate physically-absorbing elements or chemically absorbing elements, and often both. Currently, chemically-absorbing elements are frequently of the modified polyacrylate family and include sodium polyacrylate and related compounds. Such modified polyacrylate compositions can indeed absorb large amounts of liquids, typically hundreds of grams of water per gram of material. They cannot, however, be formed into fibers, and instead must be coated thereon whenever an absorbent fabric structure (typically, but not necessarily, nonwoven) is desired or required.

Although fibrous structures are available with highly absorbent characteristics, they tend to be combinations in which a highly absorbent material (e.g. the polyacrylates) is physically or chemically attached to fibers or to a fabric. As a result, they tend to be somewhat sophisticated in nature, and are thus relatively expensive.

Conventional fibers offer the advantages of fabric manufacture, but cannot generally approach the absorbency of the modified polyacrylates. For example, cotton can typically absorb water in an amount of about 10-15% by volume, wool can absorb about 10-20%, and rayon about 15-20%.

Even these absorbencies can be disadvantageous, however, because many fibers tend to lose strength or other desired fiber (or fabric) characteristics when wet. Nylon, for example, tends to stretch when wet. In contrast, polyester remains generally unaffected by moisture, but has very little inherent absorbency. Although polyester is widely used in athletic clothing because of its high strength, its wicking (as opposed to absorbing) properties, and its “wash and wear” characteristics, its low absorbency has prevented its widespread use for absorbent purposes. Nevertheless, polyester is generally inexpensive, and widely available. Its properties are well-understood as are the techniques required to manufacture polyester filament, staple fiber from filament, and yarns and fabrics from the staple. To date, however, attempts at incorporating polyester into absorbent structures have tended to be chemically or physically complex; e.g. U.S. Pat. No. 4,361,617.

Accordingly, incorporating polyester into absorbent structures as a replacement for or complement to existing structures is an attractive possibility.

### SUMMARY OF INVENTION

Therefore, it is an object of the present invention to provide a synthetic polymer fiber that has a high absorbency for water and related liquids.

The invention meets this object with a hollow polymeric filament having sufficient openings therein for said hollow filament to substantially fill with water.

In another aspect, the invention is a polyester filament having a moisture absorption capability of between about 10 and 30 percent by volume.

In yet another aspect, the invention is a hollow polyester filament having an asymmetric cross section and having sufficient openings therein for said hollow filament to substantially fill with water.

In yet another aspect, the invention is a method of forming a highly water-absorbent polyester filament by contacting a hollow polyester filament with a chemical composition in an amount and for a time sufficient to attack the hollow filament and create sufficient openings therein for the hollow filament to substantially fill with water while less than an amount that would completely open or dissolve the filament.

In a further aspect, the invention is a method of forming a highly water-absorbent polyester filament by mechanically cracking a hollow polyester filament until the filament is sufficiently open to substantially fill with water.

The foregoing and other objects and advantages of the invention and the manner in which the same are accomplished will become clearer based on the followed detailed description taken in conjunction with the accompanying drawings.

### BRIEF DESCRIPTION OF DRAWINGS

FIG. 1 is a micrograph of a hollow polyester filament prior to any treatment according to the present invention.

FIG. 2 is a micrograph of a hollow polyester filament according to a first embodiment of the present invention.

FIG. 3 is a micrograph of another portion of a hollow polyester filament according to the first embodiment of the present invention.

FIG. 4 is a micrograph of a portion of a hollow polyester filament according to another embodiment of the present invention.

FIG. 5 is a plot of capillary flow time measured against the length of a capillary opening.

### DETAILED DESCRIPTION

The present invention is a hollow filament having sufficient openings therein for the hollow filament to substantially fill (i.e., all along its length) with liquid, particularly (although not necessarily) water and water-based solutions. The detailed description is presented with an emphasis on the absorption of water and water-based solutions and suspensions. It will be understood, however, that the described invention can also be used to absorb non-aqueous liquids (e.g., organic liquids). In such cases the size of the filament, the size of the openings and the composition of the filament can all be selected to enhance the absorption of desired or expected liquids.

Polyester is a preferred filament, and the term “polyester”is used herein in its well-understood definition as a manufactured fiber in which the fiber forming substance is any long chain synthetic palmer composed of at least 85% by weight of an ester of a substituted aromatic carboxylic acid, including but not restricted to substituted terephthalate units and parasubstituted hydroxy benzoate units. This definition is consistent with that given by the Federal Trade Commission (16 C.F.R. §303.7) and is generally followed in the industry, e.g., Tortora, Fairchild”s Dictionary of Textiles, 7^{th} Edition (1996) Fairchild Publications; Dictionary of Fiber and Textile Technology (1999) Kosa; and Lewis, Hawley”s Condensed Chemical Dictionary, 12^{th} Edition, (1993) Van Nostrand Reinhold.

In preferred embodiments, the filament consists essentially of polyethylene terephthalate (“PET”), which is well understood by those of ordinary skill in this art as the condensation polymer of polyethylene glycol and terephthalic acid. PET is preferred because its production, including melt, filament, and fiber, is probably one of the best and most widely understood polymer processes known, and thus the use of PET correspondingly makes the invention widely available and easy to understand. Polyester provides additional advantages such as a low bulk density and non-gelling characteristics and its properties are well-understood from a recycling standpoint. Polyester does not exhibit, “wet collapse,” which is a particular disadvantage of some natural fibers.

The invention is not limited, however, to PET and other polyesters (e.g. polybutylene terephthalate), copolyesters, and copolymers of PET or other polyesters can be used in the invention and fall within its scope. For example, if the liquid expected or desired to be absorbed is incompatible with polyester (e.g., a polyester solvent), a more appropriate polymer can be selected for the filament. In a similar manner, the size (denier) of the filament and the size of the hollow portion can be selected based upon the wetting and wicking characteristics of the liquid.

In preferred embodiments, the invention is a staple fiber cut from the hollow filaments. Staple fibers can be used for a number of purposes, including being spun into yarns, and, in many moisture-absorbing structures, being formed into non-woven textiles. Thus, in another embodiment, the invention is a non-woven fabric formed from the hollow filaments according to the invention. In many circumstances, the staple fiber will be cut to a length of between about one-quarter inch (¼″) and two inches (2″), as this represents a common range of lengths used in many textile applications. The invention is not, however, limited to such lengths and they are merely exemplary and commonly used lengths, rather than limitations on the present invention.

The manufacture of polyester, including PET and copolymers, is well-understood. Indeed, as noted herein, such is one of the advantages of the present invention. Accordingly, the details of polyester manufacture will not be discussed herein other than as necessary to describe features of the invention. Those of ordinary skill in this art will be able to carry out the invention without undue experimentation.

Similarly, the nature and manufacture of nonwoven fabrics is also well understood in the art, and the various categories and techniques for manufacturing non-woven fabrics will not be discussed in detail herein. Exemplary discussions are set forth in many sources, including the Tortora and KoSa references set forth above, and nonwoven fabrics can likewise be formed from the staple fibers described herein without undue experimentation.

Described somewhat differently, the staple fibers cut from the hollow filaments of the invention have a length sufficient to exhibit fiber properties, and specifically a length sufficient to support a meniscus of water at each end thereof. Stated functionally, if the fibers are too short to support a meniscus, they will fail to exhibit the desired capillarity. If they are too short to behave as fibers (regardless of their absorbency), they will fail to provide the properties that make fabric structures advantageous, and will instead act as more conventional filler or matrix material.

The phenomena in which water (or other liquids) are drawn into relatively small tubes is referred to as capillary action, or alternatively as capillarity. Capillarity is defined as the action by which the surface of a liquid, where it contacts a solid, is either elevated or depressed. The elevation (e.g. water in a polyester tube) or depression (e.g. mercury in a glass tube) results from the relative attraction of the molecules of the liquid for each other and from the relative attraction of the liquid for the solid.

For a given diameter tube, the extent to which water rises depends upon balancing forces. When a tube is vertically inserted into water, the water rises to the height at which the weight of the water column just balances the capillary attraction. In some circumstances such as hollow fibers gravity is not necessarily the opposing force. Instead, as water is drawn into both ends of the fiber, it traps air therebetween. As the volume of trapped air decreases (all other factors being equal) the pressure of the trapped air increases in a well-understood manner consistent with the ideal gas law (and its more sophisticated relatives). Thus, the air pressure in the hollow fiber, rather than gravity, provides the limiting factor as to how much water a hollow staple fiber (or longer filament) can absorb.

Accordingly, in the present invention, the provision of openings along the filament or fiber allows air to escape and thus prevents the air pressure from limiting the capillary draw into the filament or fiber. In turn, this allows the filament or fiber to substantially fill with water, thus greatly increasing the absorbent capacity of the filament, of fibers cut therefrom, of fabrics made from the fibers, and of the absorbent structures made from the fabrics.

Thus, it has been unexpectedly discovered in accordance with the present invention that when the hollow filaments are opened in the manner described herein, the effect of capillary action and the number of openings is sufficient to draw water into the hollow fiber all along its length, rather than just for a short distance as would be the case with a hollow fiber that is not opened. At the same time, however, the fibers have sufficient integrity to maintain fiber characteristics, which are desirable in the intended applications.

Once the staple fibers are formed into a non-woven fabric, the non-woven fabric can be incorporated into any number of absorbent structures that use such non-woven fabrics. As set forth in the background, these can include items such as diapers, incontinence garments, sanitary napkins, tampons, filters, wipes, fabric sheets, such as bed sheets, and many other examples.

In another aspect, the invention is a polyester filament having a moisture absorption capability of between about 10 and 30% by volume, preferably between about 20 and 30% by volume and most preferably at least about 30% by volume. As in the previous embodiment, the filament consists essentially of polyethylene terephthalate. In preferred embodiments the filament is hollow and is cut into shorter staple fibers for the purpose of being incorporated into non-woven fabrics. In turn, the non-woven fabrics can be incorporated into absorbent structures such as those set forth previously.

In preferred embodiments, the hollow filament has an asymmetric cross section, the most preferable of which is a circular hollow opening that is off-center with respect to the axis of the filament and that, in turn, results in thicker and thinner walls of the hollow filament at different positions. This preferred filament can likewise be cut into staple fiber, formed in the non-woven fabric, and incorporated into absorbent structures.

The formant can also be asymmetric in its overall (i.e. external) shape and the hollow opening can likewise be other than circular. Stated differently, the invention includes circular filaments with circular hollow openings, circular filaments with non-circular hollow openings, non-circular filaments with circular hollow openings, and non-circular filaments with non-circular hollow openings.

An exemplary method of forming hollow filaments is set forth in commonly assigned U.S. Pat. No. 5,407,625, the contents of which are incorporated entirely herein by reference. An exemplary method of forming the asymmetric hollow filaments is set forth in copending and commonly assigned U.S. application Ser. No. 09/851,569, filed May 10, 2001 for, “Method and Apparatus for High-Denier Hollow Spiral Fiber,” the contents of which are also incorporated entirely herein by reference.

In another aspect, the invention is a hollow filament that consists essentially of polyester, the filament having an asymmetric cross section, and the filament having sufficient openings therein for the hollow filament to substantially fill with water. In preferred embodiments, the filament consists essentially of polyethylene terephthalate, and as in the previous embodiments can be cut into staple fiber. As mentioned previously, the staple fibers are preferably cut to lengths of between one-quarter inch and two inches to conform to the most common lengths used for fabrics, particularly non-woven fabrics. The staple fibers can in turn be formed into such a non-woven fabric and incorporated into absorbent structures as listed previously.

As noted previously herein, it appears quite evident that the advantage of the opened hollow fiber is its ability to take up water, or related liquids by capillary action. Normally, in a fully intact hollow fiber or filament, a small amount of water will be taken up, but the remaining air (or other gas) remaining in the center portions of the filament or staple fiber, will prevent the water from moving any further because the air pressure in the filament will counteract the capillary forces that are encouraging water to be drawn in.

In the invention, however, the additional openings that tend to longitudinally follow the filament or fiber allow this air to escape, thus allowing a full capillary effect to take place and for the hollow filament or staple fiber cut there from to substantially fill with water, or understood conversely, become substantially emptied of air.

In this respect, it is understood that the time (T) required for pure water to travel a distance (L) in a capillary of radius (R) can be computed by the equation given below if the water is pulled through the fiber by capillary forces.

$$T = \frac{2 {L}^{2} η}{R γ}$$

where eta is viscosity and gamma is surface tension.

If the capillary movements tends to be faster than other methods of liquid movement in a structure (e.g. the movement of liquid through the cellulose media in a diaper) the void space in the hollow fiber will become the preferred means of liquid travel and the voids in the fiber will end up being substantially filled.

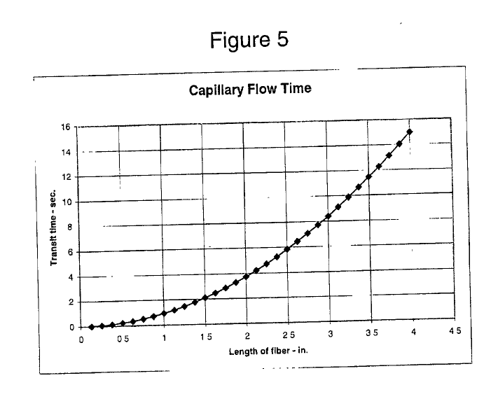

FIG. 5 is a plot of capillary flow time showing the transit time in seconds plotted against the length of an opening in inches according to the cited formula. In particular, FIG. 5 shows the time for water to move through an 18.5 micrometer opening, which is typical of polyester filament of the type discussed herein. As seen from FIG. 5 a ¼ inch long tube tends to move water much faster than it could diffuse through any related absorbent medium.

As also noted previously, when a liquid surrounds a fiber and covers both ends, the capillary forces will pull the liquid into both ends, creating pressure in the trapped air that balances the capillary force. The pressure (P) is given by the following formula:

$$P = \frac{2 γ}{R}$$

where R is the interior diameter of the capillary and gamma is again the surface tension.

Based on this formula, water in the 18.5 micron capillary would generate about 1.1 pounds per square inch (psi) which would fill about 6% of the capillary volume with a simultaneous wetting of both ends of the capillary.

Accordingly, by opening the fiber in the manner of the invention, this build up of pressure can be avoided and a full capillary effect throughout the fiber can take place leading to the high absorbency of filaments and fibers according to the invention.

In another aspect, the invention comprises the method of forming the highly water absorbent polyester filament. In this aspect, the method comprises contacting the hollow polyester filament with a chemical composition in an amount and for a time sufficient to attack the hollow filament and create sufficient openings therein for the hollow filament to substantially fill with water while less than an amount that would completely open or dissolve the filament. When a liquid is used as the contacting composition, the amount is typically expressed as a concentration.

In a first embodiment of the method, the method comprises contacting the filament with an aqueous alkali solution at an elevated temperature. The term alkali is used in its normal sense (e.g., Lewis, supra) and common synonyms include the term “base” or “basic.” Alkali solutions can also be described as those for which the pH is greater than 7. Although a number of compositions qualify, the preferred alkali solutions are the simple mineral alkalis such as aqueous solutions of sodium hydroxide, potassium hydroxide and ammonium hydroxide.

In another aspect, the method can include the step of contacting the filament with an organic solvent for polyester rather than an aqueous alkali solution. Alternatively, it has been discovered that contacting the filament with a plasticizer will likewise open the filament in the desired manner. As set forth with respect to the structural embodiments, the method comprises contacting a polyethylene terephthalate filament with the appropriate chemical composition.

In an overall aspect, the method of the invention can further comprise the steps of spinning the hollow filament from a melt prior to the step of contacting the filament with the attacking composition, neutralizing the alkali, heat-setting the filament, cutting the filament into staple fibers, then forming a non-woven fabric from the cut staple fibers, and then forming an absorbent structure from the non-woven fabric.

Neutralizing the alkali can be carried out relatively straightforwardly by contacting the filament with an acid, usually in the form of a mineral acid such as sulphuric or hydrochloric acid in an appropriate concentration, or with an appropriate organic acid such as acetic acid.

Similarly, the heat-setting step can be carried out in conventional fashion, and offers the same benefits (e.g. crystallization, heat-stability, shrinkage reduction) as it does for more conventional polyester filament.

As set forth with respect to the product aspects, in preferred embodiments, the spinning step comprises spinning a hollow filament with an asymmetric cross section. The asymmetric cross section provides a filament that will tend to preferentially open along the thinner walls and thus enhance the overall characteristics of the filament and fiber of the invention. As with the previous embodiment, the incorporated references offer exemplary techniques for initially forming the hollow filament, whether symmetric or asymmetric in cross-section.

The use of an alkali solution to treat polyester filament is generally well understood based on techniques that attempt to modify the surface characteristics of such filaments. Thus, these can be used as a useful guideline for the amount of alkali solution that will open the hollow filaments in the manner of the invention. For example, typical concentrations of sodium hydroxide will range from about 5 to 15% by weight, which corresponds to a molar (moles per liter) concentration of about 1.25 to about 3.75 M. Such concentrations of sodium hydroxide are easily available or can be made up in a straightforward manner in both laboratory and manufacturing conditions, and such details are generally well-known to those of ordinary skill in the art and can be determined without undue experimentation.

The reaction is preferably carried out at a somewhat elevated temperature, with temperatures of between about 60 and 100° C. being preferred. At lower temperatures, the reaction rate does not increase significantly, while handling such concentrated solutions at higher temperatures becomes troublesome, and the reaction tends to proceed further than desired under ordinary circumstances.

In functional terms, an insufficient reaction (e.g. in terms of concentration, temperature, reaction time, or combinations thereof) will fail to open the filaments. At the other extreme, overly-aggressive reaction parameters will open the filaments too far and eliminate the capillaries and their advantages, or even dissolve the polyester completely.

In yet another embodiment, the method of forming the highly water-absorbent polyester filament comprises mechanically cracking a hollow polyester filament until the filament is sufficiently open to substantially fill with water. Any mechanical method can be used that preserves sufficient structural integrity in the filaments. In preferred embodiments, techniques similar to calendaring or embossing can be used to open the filaments to the desired extent. These techniques are well-understood in the textile arts and can be practiced by those of ordinary skill and without undue experimentation.

In preferred embodiments, the method comprises cracking a filament that has an asymmetric cross-section, because the thinner side of the hollow filament can be mechanically attacked more easily than can a symmetric filament or fiber of otherwise identical diameter. As in the other embodiments, the method of the embodiment can also comprise the step of spinning the filament from a melt prior to the step of mechanically cracking the filament, cutting the filament into staple fiber after it has been spun from the melt, forming a non-woven fabric from the staple fibers, and forming an absorbent structure from the non-woven fabric.

With respect to the previously incorporated application Ser. No. 09/851,569, the filament can be mechanically stressed during manufacture to enhance or ease the mechanical cracking process. In particular and as set forth in the “569 application, when the asymmetric hollow filament is preferentially quenched from the side corresponding to the thinner walls, those walls will become more highly oriented than will the walls that are opposite from the clenched flow. Thereafter, if the fiber is drawn to a ratio that is high with respect to the low orientation side, the stress on the high orientation side will be greatly increased, and thus make the highly stressed portions much more susceptible to cracking without much mechanical encouragement.

In that regard, the asymmetric hollow filament is preferred in all embodiments herein because in relative terms its weaker side will always be easier to attack, either chemically or physically, than would the walls of an equivalent symmetrical hollow filament.

As in the case of the other embodiments, the use of polyethylene terephthalate is preferred because of the well-understood manner in which it can be produced, and the avoidance of any other additives that could complicate the process. It will be understood, however, that other polyesters, or polyester-based copolymers, can be used in accordance with the present invention as may be necessary or desired, and the invention is not limited to polyethylene terephthalate.

The invention provides the capability for products that can transport liquids (move liquids from point A to point B), store liquids (retain liquid under some level of mechanical or thermal stress), acquire liquids (spontaneously attract the liquid without working to move the liquid into the fiber), and distributes liquid (spreads liquids from point A to point B in a desired manner including what is in between).

In practicing the invention, the contact angle between the liquid and the polymer and the viscosity of the liquid tend to be more critical for the movement of the liquid than the chemistry of the polymer itself. In this regard, the invention can compliment or enhance the use of surface active agents in controlling the viscosity, the wetting and contact angles, and the surface tension of water or any other appropriate liquid for which the hollow filaments of the invention are the absorbent material.

The invention also provides the capability to control pore size in a number of ways. A first way is, of course, the size of the hollow opening in the filament. Those familiar with the behavior of liquids will, however, also recognize that the openings between the individual filaments, regardless of whether the filaments are hollow, also provide the basis for a certain amount of absorbency. Thus, in one sense, the invention can be considered to include both internal pores (opening within individual filaments) and external pores (the spaces between individual filaments). Because well-known synthetic manufacturing processes can control the size of the filament and the size of the hollow opening, the pore size can likewise be controlled, a feature which is simply unavailable with natural fiber. Accordingly, the diameter of the filament, the length of the filaments, and the sizes of the internal openings can all be combined to give optimal results for absorbing particular liquids in a number of various circumstances. In this regard, it is well understood that smaller pore sizes will tend to wick faster while holding less liquid. Larger pore sizes wick more slowly but will hold greater volume of liquid than smaller pore sizes. Accordingly, the ability to literally design pore sizes for an absorbent medium or substrate offers a tremendous advantage. To repeat, the invention provides the capabilities to do both larger and smaller pores at the same time; i.e., within the same material. For example, smaller, more rapidly-wicking pores can be created as the hollow portions within the filament, while the size of the filament and the length to which it is cut can be controlled to produce larger, more volume-absorbing pores between the individual fibers.

The ability to adjust the pore size in the manner described leads to enhanced performance characteristics at any given bulk density. Typically, the polyester filament of the present invention can be packed more tightly and still get an equivalent pickup, as compared to other types of absorbent materials. Thus, the material of the invention can be used in place of other absorbent materials to give an equivalent absorbency at a lower bulk density, or a greater absorbency at the same bulk density, depending upon which is more advantageous or necessary under given circumstances.

In terms of mechanically cracking filaments, the adjustment of the calendaring or embossing step can create a desired relationship between the cracked frequency, the void size within the filament, and the space between filaments as well.

The invention, although quite suitable for incorporation with polyester filament, is not limited to polyester filament and other well understood and straightforwardly manufactured synthetic polymer filaments can also be used including, but not limited to, those of polyethylene or polypropylene. Because the variations in polymers and polymers can be almost endless, it is not the purpose of this specification to attempt to recite every particular permutation of polymer that can be used in accordance with the present invention. It will be understood, however, that a large variety of polymers and polymer formulations can be incorporated without departing from the scope of the claimed invention.

As a further advantage, the value delivered in terms of absorbency is quite high based on cost, particularly where polyester is used for the filament. Stated differently, most other absorbent materials are sufficiently chemically sophisticated to raise cost issues. Polyester filament is, however, relatively inexpensive compared to many specialty chemicals, and thus its use in absorbent products is likewise expected to offer a significant economic advantage.

In another aspect, the invention is a staple filament having a coaxial opening entirely therethrough. The filament has a length defined by (and between) the minimum length sufficient to support a meniscus of water in the coaxial opening and a maximum length at which the filament will fill entirely with a liquid selected from the group consisting of water and water-based solutions and suspensions. As set forth earlier, when the hollow filament exceeds a particular length, pressure from air trapped between the two meniscuses will prevent the filament from filling completely. Thus, the maximum length can also be defined as the length above which air pressure between a meniscus at each end of the filament will prevent the opening from filling entirely with the selected liquid. Accordingly, a length at which the filament will fill entirely with water or a related water-based solution or suspension is the appropriate maximum length. Making the filament any longer serves no absorption purpose, although longer filaments may be used for other purposes. Alternatively, making the filament shorter offers no advantage from an absorption standpoint, although shorter lengths also may be selected for some other purpose.

It will be understood that an appropriate filament length for absorbing any particular liquid or type of liquid can be easily determined without undue experimentation. For example, many body fluids are water-based, such as blood, urine, and perspiration. The wetting and viscosity characteristics of these liquids are well understood in the art because they are already the subject of intense interest for various garments, bed clothes, and the like, prevalent examples of which are infant diapers. Accordingly, it is not the purpose of the present specification to offer descriptions of all sorts of liquids, but it will be understood that the behavior of any particular type of liquid, including non-aqueous liquids (and their solutions and suspensions), with respect to a particular length of hollow staple fiber can be quickly determined.

As in the previous embodiments, the preferred material for the filament is polyester, with polyethylene terephthalate being most preferred. In most circumstances, the filament will have a length of less than about one-half inch with a length of about one-quarter inch being most preferred as it is a relatively standard size for many related items and materials.

The fiber denier typically falls within a range bracketed by “coarse”deniers on the lager end and “microdeniers” on the smaller end. Given that microdenier filaments are typically defined as having deniers less than one, and coarse filaments as those with a denier of about 45 or above, the staple filament according to the invention will typically have a denier of between 1 and 45. Smaller deniers are generally more useful in the invention in many circumstances and thus a more preferred range is a denier between 1 and 10, with a denier of between about 1 and 3 being most preferred.

In a related aspect, the invention is a method of forming the highly absorbent filament comprising the steps of spinning the hollow filament at a denier of between 1 and 45, quenching the filament, and then cutting the filament into short staple fibers having a length defined by the maximum length sufficient to support a meniscus of water in the coaxial opening and a maximum length at which the filament will fill entirely with a liquid selected from the group consisting of water and water-based solutions and suspensions. The filament is preferably spun from polyester, with preferred deniers being between about 1 and 10, and most preferred deniers being between about 1 and 3. The method likewise comprises the step of cutting the filament into staple fibers less than about one-half inch in length and more preferably into staple fibers about one-quarter inch in length.

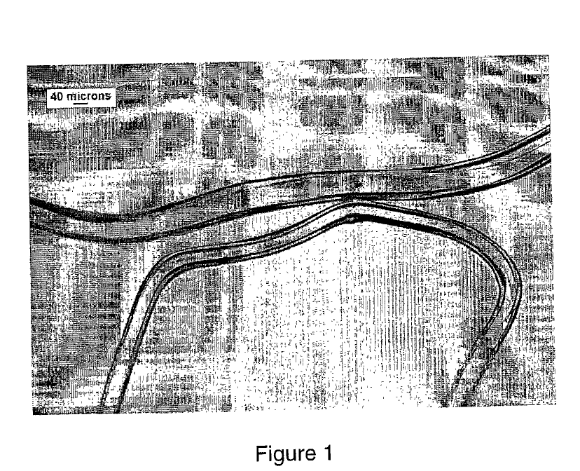

Filaments of the invention are illustrated in the photographs included herein as FIGS. 1 through 4. FIG. 1 is a micrograph of hollow fiber of the type produced by the method of previously incorporated application Ser. No. 09/851,569, and illustrates portions of the walls of the fiber and the hollow central portion.

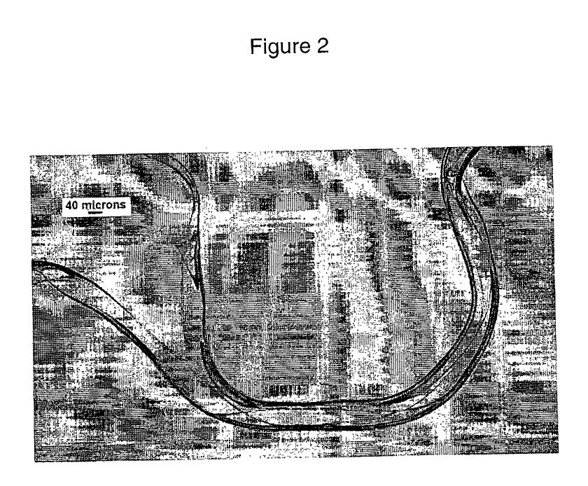

FIG. 2 is a micrograph of a filament that has been opened according to the method of the present invention. In particular, the filament of FIG. 2 is the result of treating a filament of the type illustrated in FIG. 1 with sodium hydroxide. As FIG. 2 shows, the treatment causes both a full opening of the filament, as well as partial longitudinal openings that follow the filament without separating it entirely.

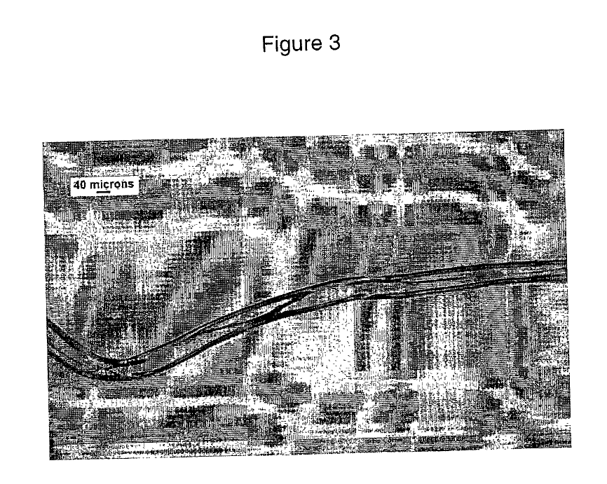

FIG. 3 is a micrograph of another portion of the filament treated in the same manner as the filament illustrated in FIG. 2. Although FIG. 3 does not show any fully separated filament, it does illustrate a series of longitudinal openings in the filament that provide the capillary action of the invention.

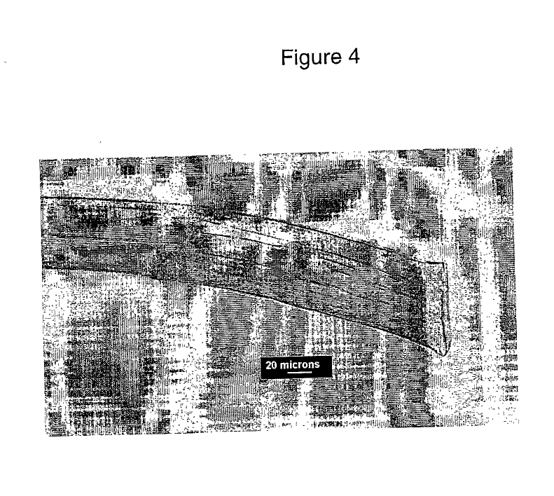

FIG. 4 is a micrograph of a hollow fiber that has been treated with a plasticizer. The visible longitudinal cracks provide the openings that enhance the capillarity characteristics of the filament.

All of these micrographs illustrate that when the filament is opened, there are structural opportunities available for capillary action that previously did not exist and that provide for the great absorbency exhibited by the present invention.

In the drawings and specification there has been set forth a preferred embodiment of the invention, and although specific terms have been employed, they are used in a generic and descriptive sense only and not for purposes of limitation, the scope of the invention being defined in the claims.

1. A hollow filament having sufficient openings therein for said hollow filament to substantially fill with liquid.

2. A hollow polyester filament having sufficient openings therein for said hollow filament to substantially fill with a liquid selected from the group consisting of water, water-based solutions, and water-based suspensions.

3. A hollow filament according to claim 1 consisting essentially of polyethylene terephthalate.

4. A staple fiber cut from the hollow filament of claim 1.

5. A staple fiber according to claim 4 and having a length sufficient to exhibit fiber properties.

6. A staple fiber according to claim 4 and having a length sufficient to support meniscus of water at each end thereof.

7. A staple fiber according to claim 4 having a length of between about one-quarter inch and two inches.

8. A nonwoven fabric formed from a plurality of staple fibers according to claim 4.

9. A nonwoven fabric formed from a plurality of staple fibers according to claim 7.

10. An absorbent structure that includes a nonwoven fabric according to claim 9.

11. A hollow filament according to claim 1 wherein both said filament and its hollow portion have respective circular cross section.

12. A hollow filament according to claim 1 wherein said filament has a circular cross section and said hollow portion has a non-circular cross section.

13. A hollow filament according to claim 1 wherein said filament has a non-circular cross section and said hollow portion has a circular cross section.

14. A hollow filament according to claim 1 wherein said filament has a non-circular cross section and said hollow portion has a non-circular cross section.

15. A hollow staple fiber consisting essentially of polyethylene terephthalate and having sufficient openings therein for said staple fiber to substantially fill with water.

16. A polyester filament having a moisture absorption capability of between about 10 and 30 percent by volume.

17. A filament according to claim 16 consisting essentially of polyethylene terephthalate.

18. A hollow filament according to claim 16.

19. A hollow filament according to claim 16 wherein both said filament and it s hollow portion have respective circular cross section.

20. A staple fiber cut from the filament of claim 16.

21. A nonwoven fabric formed from the staple fiber of claim 20.

22. An absorbent structure that includes a nonwoven fabric according to claim 21.

23. A hollow filament according to claim 18 and having an asymmetric cross section.

24. A hollow filament according to claim 23 wherein both said filament and it s hollow portion have respective circular cross section and said hollow portion is not coaxial with said filament.

25. A staple fiber cut from the filament of claim 23.

26. A nonwoven fabric formed from the staple fiber of claim 25.

27. An absorbent structure that includes a nonwoven fabric according to claim 26.

28. A staple fiber consisting essentially of polyethylene terephthalate and having a moisture absorption capability of between about 10 and 30 percent by volume.

29. A hollow filament having an asymmetric cross section and having sufficient openings therein for said hollow filament to substantially fill with liquid.

30. A hollow polyester filament having an asymmetric cross section and having sufficient openings therein for said hollow filament to substantially fill with a liquid selected from the group consisting of water, water-based solutions, and water-based suspensions.

31. A filament according to claim 29 consisting essentially of polyethylene terephthalate.

32. A filament according to claim 29 wherein both said filament and its hollow portion have respective circular cross sections and wherein said hollow portion is not coaxial with said filament.

33. A staple fiber cut from the filament of claim 29.

34. A staple fiber according to claim 33 having a length of between about one-quarter inch and two inches.

35. A nonwoven fabric formed from a plurality of staple fibers according to claim 34.

36. An absorbent structure that includes a nonwoven fabric according to claim 35.

37. A hollow staple fiber consisting essentially of polyethylene terephthalate;
said staple fiber having sufficient openings therein for said staple fiber to substantially fill with a liquid; and
said staple fiber and its hollow portion having respective circular cross sections and wherein said hollow portion is not coaxial with said staple fiber.

38. A hollow staple fiber according to claim 37 having sufficient openings therein for said staple fiber to substantially fill with a liquid selected from the group consisting of water, water-based solutions, and water-based suspensions.

39. A method of forming a highly water-absorbent polyester filament, the method comprising:
contacting a hollow polyester filament with a chemical composition in an amount and for a time sufficient to attack the hollow filament and create sufficient openings therein for the hollow filament to substantially fill with a liquid while less than an amount that would completely open or dissolve the filament.

40. A method according to claim 39 comprising creating sufficient openings for the hollow filament to substantially fill with a liquid selected from the group consisting of water, water-based solutions, and water-based suspensions.

41. A method according to claim 39 comprising contacting the filament with an aqueous alkali solution.

42. A method according to claim 41 comprising contacting the filament with the aqueous alkali solution at an elevated temperature.

43. A method according to claim 41 comprising contacting the filament with an aqueous solution selected from the group consisting of sodium hydroxide, potassium hydroxide and ammonium hydroxide.

44. A method according to claim 39 comprising contacting the filament with an organic solvent for polyester.

45. A method according to claim 39 comprising contacting the filament with a solvent selected from the group consisting of: benzene, esters and ketones.

46. A method according to claim 39 comprising contacting the filament with a plasticizer.

47. A method according to claim 39 comprising contacting a polyethylene terephthalate filament.

48. A method according to claim 39 and further comprising the step(s) of spinning the hollow filament from a melt prior to the step of contacting the filament with the attacking composition.

49. A method according to claim 48 comprising spinning a hollow filament with an asymmetric cross section.

50. A method according to claim 39 and further comprising cutting the filament into staple fibers.

51. A method according to claim 50 and further comprising forming a nonwoven fabric from the cut staple fibers.

52. A method according to claim 41 and further comprising neutralizing the filament after contacting the filament with the aqueous alkali solution.

53. A method according to claim 39 and further comprising the steps of:
heat setting the filament;
cutting the filament into staple fibers; and
baling the cut staple fibers;
all following the step of contacting the filament with the chemical composition.

54. A method of forming a highly absorbent synthetic polymer filament, the method comprising:
contacting a hollow polymeric filament with an organic solvent for the polymer in an amount and for a time sufficient to attack the hollow filament and create sufficient openings therein for the hollow filament to substantially fill with a liquid while less than an amount that would completely open or dissolve the filament.

55. A method according to claim 54 comprising creating sufficient openings for the hollow filament to substantially fill with a liquid selected from the group consisting of water, water-based solutions, and water-based suspensions

56. A method according to claim 54 comprising contacting a hollow polyester filament with the solvent.

57. A method of forming a highly absorbent synthetic polymer filament, the method comprising:
mechanically cracking a hollow polymeric filament until the filament is sufficiently open to substantially fill with a liquid.

58. A method according to claim 57 comprising mechanically cracking a hollow polyester filament until the filament is sufficiently open to substantially fill with a liquid selected from the group consisting of water, water-based solutions, and water-based suspensions.

59. A method according to claim 57 comprising cracking a filament that has a asymmetric cross section.

60. A method according to claim 59 and further comprising the step of spinning the asymmetric filament from a melt prior to the step of mechanically cracking the filament.

60. A method according to claim 59 and further comprising the step of spinning the asymmetric filament from a melt prior to the step of mechanically cracking the filament.

61. A method according to claim 59 and further comprising cutting the filament into staple fiber.

62. A method according to claim 61 and further comprising forming a nonwoven fabric from the staple fibers.

63. A method according to claim 59 and further comprising the step of spinning the asymmetric filament prior to the step of mechanically cracking the filament.

64. A method according to claim 57 and further comprising spinning the hollow filament from a melt prior to the step of cracking the filament.

65. A method according to claim 64 and further comprising cutting the filament into staple fiber.

66. A method according to claim 65 and further comprising forming a nonwoven fabric from the staple fibers.

67. A method according to claim 57 comprising cracking a filament consisting essentially of polyethylene terephthalate.

68. A method according to claim 57 and further comprising the steps of heat stting the filaments;
cutting the filaments into staple fiber; and
baling the cut staple fibers.

69. A method of forming a highly absorbent polyester filament, the method comprising:
spinning an asymmetric hollow filament from a melt;
preferentially quenching the filament to create greater and lesser degrees of
polymer orientation along the filament;
drawing the filament to a desired draw ratio;
heat setting the drawn filament; and
mechanically cracking a hollow polyester filament until the filament is sufficiently open to substantially fill with a liquid.

70. A method according to claim 69 comprising mechanically cracking the filament until the filament is sufficiently open to substantially fill with a liquid selected from the group consisting of water, water-based solutions, and water-based suspensions.

71. A method according to claim 69 wherein the drawing step comprises drawing the filament to degree that highly stresses the more highly oriented portions of the filament.

72. A staple filament having a coaxial opening entirely therethrough, the filament having a length defined by the minimum length sufficient to support a meniscus of water in the coaxial opening and a maximum length at which the filament will fill entirely with a liquid selected from the group consisting of water and water-based solutions and suspensions.

73. A staple filament according to claim 72 wherein the maximum length is the length above which air pressure between a meniscus at each end of the filament will prevent the opening from filling entirely with the selected liquid.

74. A staple filament according to claim 72 comprising polyester.

75. A staple filament according to claim 72 comprising polyethylene terephthalate.

76. A staple filament according to claim 72 having a length less than about one-half inch.

77. A staple filament according to claim 72 having a length of about one-quarter inch.

78. A staple filament according to claim 72 having a denier of between about 1 and 45.

79. A staple filament according to claim 72 having a denier of between about 1 and 10.

80. A staple filament according to claim 72 having a denier of between about 1 and 3.

81. A method of forming a highly absorbent filament comprising:
spinning a hollow filament at a denier of between about 1 and 45;
quenching the filament; and
cutting the filament into short staple fibers having a length defined by the minimum length sufficient to support a meniscus of water in the coaxial opening and a maximum length at which the filament will fill entirely with a liquid selected from the group consisting of water and water-based solutions and suspensions.

82. A method according to claim 81 comprising spinning a polyester hollow filament.

83. A method according to claim 81 comprising spinning the filament to a denier of between about 1 and 10.

84. A method according to claim 81 comprising spinning the filament to a denier of between about 1 and 3.

85. A method according to claim 81 comprising cutting the filament into staple less than about one-half inch in length.

86. A method according to claim 81 comprising cutting the filament into staple about one-quarter inch in length.
